(19) United States
(12) Patent Application Publication
(10) Pub. No.: US 2008/0143548 A1
(43) Pub. Date: Jun. 19, 2008

(54) On-demand alerting and response system and method

(75) Inventors: Erik K. Grimmelmann, New York, NY (US); Henry Hugh Crawford, Brooklyn, NY (US); Susan E. Kresge, Westfield, NJ (US); Henry H. Lowengard, Kingston, NY (US); John Bruce Morrow, Piscataway, NJ (US); Jeff M. Pascal, Canbury, NJ (US); Jorge C. Satorre, Sussasunna, NJ (US); Jason A. Valdina, Mohigan Lake, NY (US); Santiago Vasquez-Marulanda, New York, NY (US)

Correspondence Address: SWN Communications Inc., Suite 500, 224 West 30th Street, New York, NY, 10001, US

(73) Assignee: SWN Communications Inc.

(21) Appl. No.: 12/002,395

(22) Filed: Dec. 17, 2007

Related U.S. Application Data
(60) Provisional application No. 60/875,621, filed on Dec. 19, 2006.

(51) Int. Cl. G08B 27/00; H04M 3/56; G06Q 99/00

(52) U.S. Cl. 340/691.5; 379/202.01; 705/1

(57) ABSTRACT

A method of enabling one or more senders to simultaneously alert one or more contacts located anywhere around the world over one or more communication networks, each contact having at least one communication device for receiving alert data. The method including the steps of generating and maintaining one or more scenarios each including a set of destination contacts selected from the one or more contacts, a composition of alert data, and delivery rules; initiating execution of at least one of the scenarios to send the alert data to each contact in the set of destination contacts; and managing sending of the alert data by applying the delivery rules.

### CROSS-REFERENCE TO RELATED APPLICATION

This application is based on and claims priority to U.S. Provisional Patent Application Ser. No. 60/875,621, filed on Dec. 19, 2006 and entitled “ALERTING AND RESPONSE SERVICE”, the entire contents of which are hereby incorporated by reference.

### BACKGROUND OF THE INVENTION

The present invention relates to notification services and more particularly to on-demand, subscription-based alerting service that manages one- and two-way communication in time-critical situations.

### SUMMARY OF THE INVENTION

It is an object of the present invention to enable senders immediately upon occurrence of an event to simultaneously alert multiple contacts over various means of communication.

It is another object of the present invention to enable senders to receive status information of delivery of alert messages to the contacts.

It is yet another object of the present invention to utilize partner services to provide event notification for automatically triggering sending of alert messages.

Provided is a method of enabling one or more senders to simultaneously alert one or more contacts located anywhere around the world over one or more communication networks, each contact having at least one communication device for receiving alert data. The method including the steps of generating and maintaining one or more scenarios each including a set of destination contacts selected from the one or more contacts, a composition of alert data, and delivery rules; initiating execution of at least one of the scenarios to send the alert data to each contact in the set of destination contacts; and managing sending of the alert data by applying the delivery rules.

Also provided is system for enabling one or more senders to simultaneously alert one or more contacts located anywhere around the world, each contact having at least one communication device serviced by one or more service providers. The system including a service complex including at least one computing device, a database, and one or more communication networks connected to the service complex for communicating alert messages, the service complex further including a user interface for administering scenarios and initiating sending of the alert messages; an alert generation service for communicating with external information sources to receive notification to send the alert; and a messaging engine for sending the alert messages to the contacts' designated communication devices managed by available service providers.

Other features and advantages of the present invention will become apparent from the following description of the invention that refers to the accompanying drawings.

### BRIEF DESCRIPTION OF THE DRAWING(S)

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 is a diagram of message navigation enabled by the present invention;

FIG. 2 is a block diagram illustrating necessary components leading to the scenario execution;

FIG. 3 is a diagram of internal and external components of a service complex of the present invention;

FIG. 4 is a diagram of distribution of the service complex and its support components over the Internet and telephone network;

FIG. 5 is a diagram of hardware and network components of the service complex;

FIG. 6 is a diagram of interaction of internal and external software processes and databases of the service complex and a partner service;

FIG. 7 is a diagram of interaction of an external sender application and a web service interface of the service complex;

FIGS. 8a-8e are diagrams of steps performed by the software processes to achieve the object of the present invention; and

FIG. 9 is a diagram of a sequence of steps from an initial setup of partner service alerts by the sender to sending of the alert message by the service complex to the customer.

### DETAILED DESCRIPTION OF EMBODIMENTS OF THE INVENTION

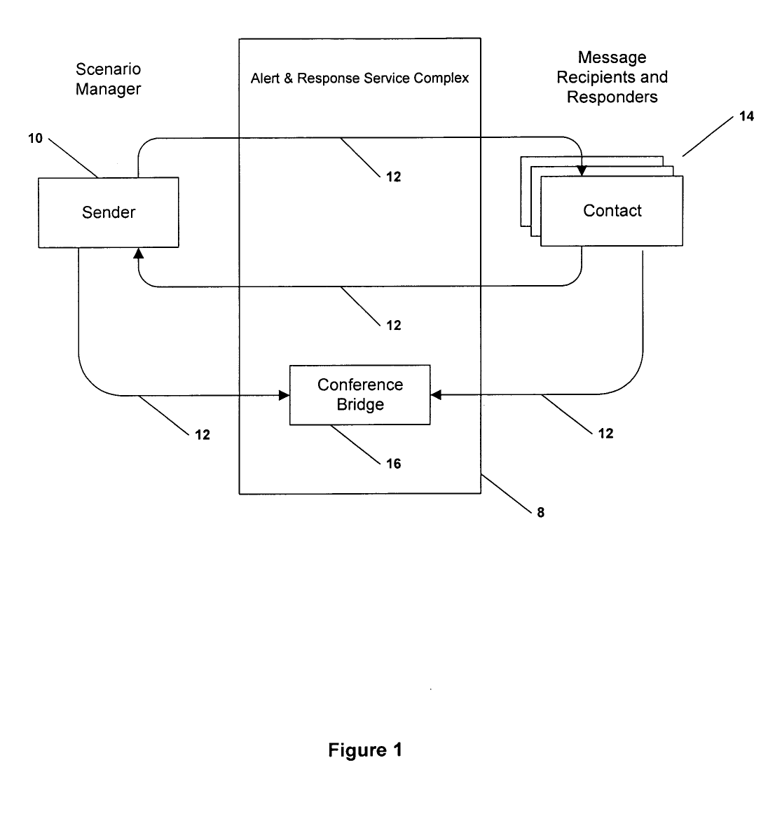

As shown in FIG. 1, the present invention enables one or more senders 10 to send alert and other types of newly composed or pre-existing messages to one or more contacts 14 over a combination of communication networks 12 controlled by the alert and response service complex 8. The senders 10 may include various organizations, companies, and corporations represented by authorized personnel, e.g., management. The contacts 14 may include senders' 10 employees, customers, and other designated groups. The messages may be sent using communication devices, such as land-line based telephones, cell phones, Internet phones, i.e., using voice over Internet protocol (VoIP) technology, personal digital assistants (PDAs), Black Berry devices, etc., or computing devices wire or wirelessly Internet connected and executing web browser programs, e.g., Microsoft Explorer, Mozilla Firefox, etc., or proprietary programs. Each of the one or more senders 10 is enabled to simultaneously send messages to their respective contacts 14, which may number from single digits to tens, hundreds, and thousands and may be located anywhere around the world. The messages may be sent via common voice- and text-based communication points in a form of telephone calls, e-mail messages, instant text messages, etc.

Optionally, each of the contacts 14 may chose to respond to the senders 10 directly via the communication networks 12 or by joining the sender in a pre-arranged conference bridge 16. A conference bridge connects multiple participants over a phone line or broadband Internet connection for a conference call. Connection of the contacts 14 to the conference bridge may be initiated as part of the delivery of the sent message. Responses are typically made by the contacts 14 in reply to a request or prompt from the sender that the response be made. Such request or prompts may be contained in the sent message. The contacts' 14 responses may be received using the same medium and form as sent, e.g., an e-mail message sent in response to an e-mail message, or any other medium selected form that listed above, e.g., an e-mail message sent in response to a voice cell phone message. It is understood that for proper response reception, the response medium is available to both the sender and the contact.

### Scenarios

The sending and receiving of the messages or alerts is enabled by the service complex 8, which is described below. The service complex 8 may include one or more network-connected distributed computing devices. These devices perform real time verification and recording of delivery and status of the sent and received messages as well as enable presentation or display of voice and text contact's 14 responses as they are generated. Tasks performed by the service complex 8 further include generation and maintenance of scenarios.

The scenarios are sets of commands instructing the service complex when the pre-stored alert data or messages are to be sent. The scenarios enable sending of the alert data without prompting by the senders and may be formulated or initiated by the senders when needed or in advance of sending. Alternatively, a scenario may be partially prepared in advance of sending while the remaining details may be filled-in just prior to initiation of the scenario. Initiation of the scenarios can be achieved manually, automatically at the time of preparation or automatically based on at least one predetermined event.

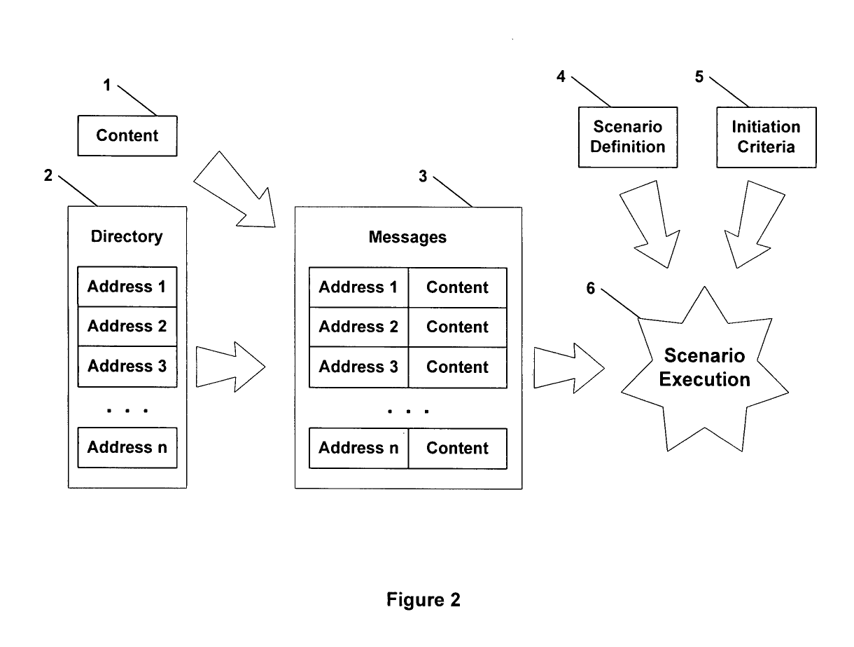

As illustrated in FIG. 2, the scenarios may include at least the following elements, a message or content 1 of the alert data to be sent, a list or a directory of contacts 2 specifying to whom, via which media, and to what addresses and/or telephone number the messages 3 or the alert data is to be sent, the scenario's definitions 4, i.e., the rules describing the details of how the message is to be delivered, how many times to dial the telephone number and with what interval between the attempts, what to do if the contact is not reached, and whether or not to solicit responses to the sent messages, and criteria for the message initiation 5, i.e., specify when, or under what circumstances, the execution of the scenario 6 is to be initiated.

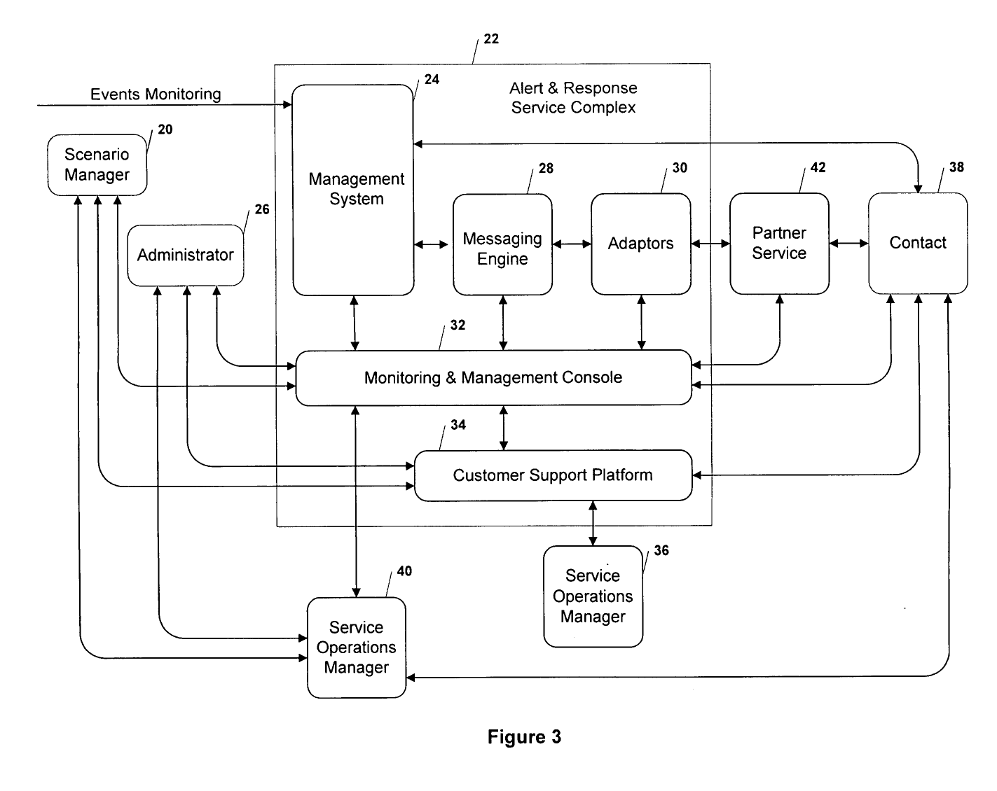

FIG. 3 shows an example of preparation of the scenario's four elements. A sender, using a computing device running commonly available Internet browser programs and/or a proprietary software program, may directly or indirectly interact with a service complex 22. Indirect interaction may be mediated by a sender server 20 which interacts with the service complex 22 using, for example web-services-based application program interfaces (APIs) provided by the service complex 22.

A direct interaction may be achieved by the sender accessing a management system 24 on the service complex 22, to perform account maintenance and/or manage the scenarios. The management system 24 provides tools with which the sender can configure and manage their accounts on the service complex 22 and create, initiate, track, and manage message delivery scenarios. The management system 24 may also monitor external events, e.g., the weather, the stock market, the news, etc., which may be used as triggers to automatically initiate the scenarios based on the sender-specified rules.

The directories of contacts, included in the senders' scenarios may be maintained directly by each sender, or senders' appointed administrators 26, or by the contacts themselves. Further, the directories of contacts may be imported from external sources by the administrators 26, or held on sender servers 20 and referenced at the time of the scenario execution. Similarly, a corporate personnel directory contained on each sender's own server 20 may be referred or linked to as the directories of contacts in the scenario.

The scenario may be executed or initiated manually, at a preset time, or based on one or more external events. Once the scenario has been initiated, it is managed by a messaging engine 28 which handles such functions as application of rules contained within a scenario; prioritizing messages to meet service level agreements (SLAs) and other contractual commitments while minimizing costs; routing messages to specific messaging networks; tracking the status of the execution of a scenario and of the messages contained within the scenario; creating message detail records for billing; and monitoring the status and performance of the transaction engine. The messaging engine 28 manages the execution of message delivery scenarios defined using the management system 24 and contains two principal subcomponents—scenario execution and usage recording. The scenario execution subcomponent includes the sub-functions of message prioritization, message routing, scenario and message tracking, and status and performance monitoring.

When the scenario is initiated, the messages are “formatted” for the specific delivery medium selected by the sender and by adaptors 30 specific to each delivery media and/or service provider. The adaptors 30 link the messaging engine 28 with partner messaging networks 42 or directly to the sender servers 20. The individual adaptors 30 format messages for delivery using a specific delivery medium and the service complex 22, listen for confirmations of success or failure of the message delivery attempts and, where possible, track on-line presence of a particular contact's 38 device and its availability to receive the message.

An example of the presence of the contact's 38 device is a list of on-line buddies provided by most instant messaging (IM) clients in conjunction with the associated IM service. The presence can be monitored continually, i.e., outside of the scenarios being executed, or within the active scenarios. In the later case, depending on the above-discussed rules contained within the scenario definition, the presence of a particular contact's 38 device would be checked prior to the actual dispatching of the message to that device. If the device is not present, no message is sent to it. Instead, an alternate contact's 38 device is used or no message is sent at that time.

The status and performance of the functions of the service complex 22 are monitored in real-time through a monitoring and management console 32. The monitoring and management console 32 also functions as a control interface and is configurable to monitor external events and sender servers 20 directly connected to the service complex 22 and containing contact directories. The monitoring and management functions are made available only to those with authorized access privileges. In general, access privileges may be role-based. The monitoring and management console 32 may also be customized to generate automated alerts based on abnormal conditions such as system overload or message delivery delays. Further, the monitoring and management console 32 enables an operations manager 36 to manage the service complex 22.

The service complex 22 further includes a customer support platform 34 for providing customer support, either directly to the contacts 38, administrators 26, and the sender servers 20, or through a customer support representative 40. The customer support platform 34 provides the customer support representatives 40 with tools that enable efficient support of the senders and includes self-help features for senders, including documentation, answers to frequently asked questions (FAQs), and mechanisms, such as real-time chat, for additional support. In addition, the customer support platform 34 enables customer support representatives to view senders' data and directly address their issues. For example, if appropriate, the customer support representative 40 may be enabled to review a sender's account and reset a password.

A partner messaging networks or partner services 42 provide a mechanism for delivery of the messages through the service complex 22 by providing a rich and robust set of delivery paths to a wide variety of customer's devices. Adding support of a new device is as simple as creating a new adaptor and establishing a business arrangement with the appropriate service provider 42. Where messaging costs are charged to the message recipient, no business relationship is typically required between the service complex 22 and the service provider 42.

Depending on an agreement with the partners, the “ports” of the partner messaging networks 42 may be dedicated to the service complex 22 or shared with the partners' other customers. If the ports are dedicated, they may be either shared among all senders or dedicated to a specific sender. The dedicated ports may be reserved for use by a specific sender. When not needed by the sender for whom reserved, these ports may be made available to other senders.

### Complexes' Hosting

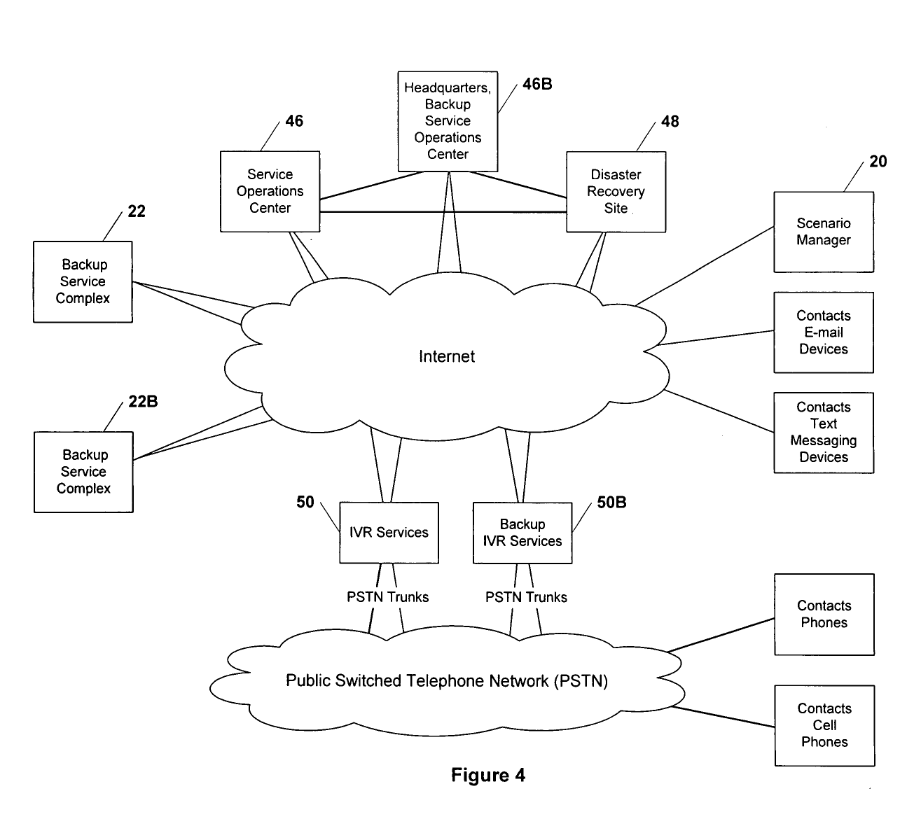

FIG. 4 illustrates an exemplary distribution of processing performed by the present invention over a number of sites that fall into the following groups: service complexes 22 including backups 22B; operations centers 46 including corporate headquarters backup service operations center 46B; disaster recovery 48, and outsourced IVR provider 50 and outsourced IVR backup 50B.

The service complexes 22 and 22B are high-availability processing nodes which include redundant instantiations of the management system 24, the messaging engine 28, adaptors 30, the monitoring and management console 32, and the customer platform 34. Each service complex 22 and 22B is designed to be highly available and to have no single point of failure. In addition, the service complex 22 and 22B utilizes multiple geographically distributed, redundant complexes which provide an additional layer of redundancy. Each complex may be located in a secure telephone-company-operated Tier 1 hosting facility providing redundant, highly available infrastructure, including power; heating ventilation, and air conditioning; fire suppression; physical security; and data connectivity.

The operations centers 46 and 46B are nodes that “run” operations mangers' 36 day-to-day tasks of monitoring and managing the service complexes 22. They include redundant Internet connectivity and redundant connectivity to the Public Switched Telephone Network (PSTN) and connectivity to a Headquarters node, discussed below, by a dedicated 10 Mb/s Ethernet private line connection circuit; may include a conditioned and uninterruptible power supply with battery backup. The battery backup provides, e.g., 60 minutes of power for all essential systems, sixty minutes is approximately twice the interval needed to relocate personnel from the operations centers to a nearby dedicated backup site. The disaster recovery site 48 is provided as a dedicated site and serves as an emergency location for the operations mangers 36 and customer support representatives 40.

The service complex 22 has no single point of failure, as there is no single point of failure in the management or operations of the service complex 22, which is managed from a principal operations center. In addition, personnel in backup locations are cross-trained so that in an emergency they could step in and operate the service should the personnel in the principal operations center be unable to do so. Should both facilities be unavailable, service complex 22 personnel would be able to perform their service operations functions over any available Internet connection using remote access to the operations Virtual Private Network (VPN). Further, offsite backups of all key data at multiple locations and backup systems can be brought online quickly should its redundant primary operations sites fail. The principal and backup service facilities have redundant Internet and PSTN connectivity. In addition the two locations are connected by a dedicated T1 private line circuit.

The service complex 22 has a dedicated disaster recovery site 48 that serves as an emergency location for the service complex 22, operations mangers 36, and customer support representatives 34. In addition to serving as a backup location for the operations center and customer support, the disaster recovery site 48 is equipped with a service complex 22 which can be activated as needed. The disaster recovery site is equipped for stand-alone operations. However, if connectivity between the disaster recovery site and the operations center and/or the Headquarters 46B is available, all of the resources at these facilities, including the Internet and PSTN connectivity, will be available to the disaster recovery site.

The disaster recovery site 48 includes redundant commercial power feeds, redundant uninterruptible power supplies (UPS), redundant power distribution units (PDU), and a backup generator. The batteries attached to the UPS may support full load for at least 48 hours of operations and the generator has enough fuel on site for at least 48 hours of operation. The power controls and backup generators are tested and maintained on regular basis. The disaster recovery site 48 further includes redundant Internet connectivity and redundant connectivity to the PSTN and is connected to the headquarters 46B by a dedicated T1 private line circuit and to the operations center by a dedicated 10 Mb/s Ethernet connection.

The outsourced IVR provider 50 and 50B contain XML-PSTN adaptors. All of the sites are connected via the Internet and the XML-PSTN adaptors connect both to the Internet and to the PSTN. These sites link the service complexes 22 to the PSTN. Similarly, each of the partner services 42 operates multiple redundant sites and each such site has redundant lines to the PSTN. For security reasons, connections among the internal sites, i.e., the complexes 22, the operations centers 46, and the disaster recovery sites 48 may be encrypted using, for example, the Cisco VPN technology. The traffic between the complexes 22 and the XML-PSTN adaptor sites 50 may be protected, e.g., using 128-bit Secure Sockets Layer (SSL) encryption.

The features and benefits provided by the hosting facilities may include dual, redundant Internet connections. The hosting facility connects to the larger Internet through the hosting provider's own IP backbone and, potentially, the IP networks of other service providers. Within each hosting facility, the hosting provider connects to its IP backbone via redundant routers 51. Should one router 51 fail, other redundant routers 51, automatically take over and carry the traffic. The hosting provider provides its hosting customers, including Ethernet-based Internet connectivity through redundant switches. Should one switch fail, the other, redundant switches, automatically carries the traffic. The complex 22 is connected to the hosting provider's Ethernet switches through a pair of redundant Cisco PIX 515E firewalls with automatic failover between them. These firewalls provide a variety of protection against intrusion attempts, both accidental and intentional.

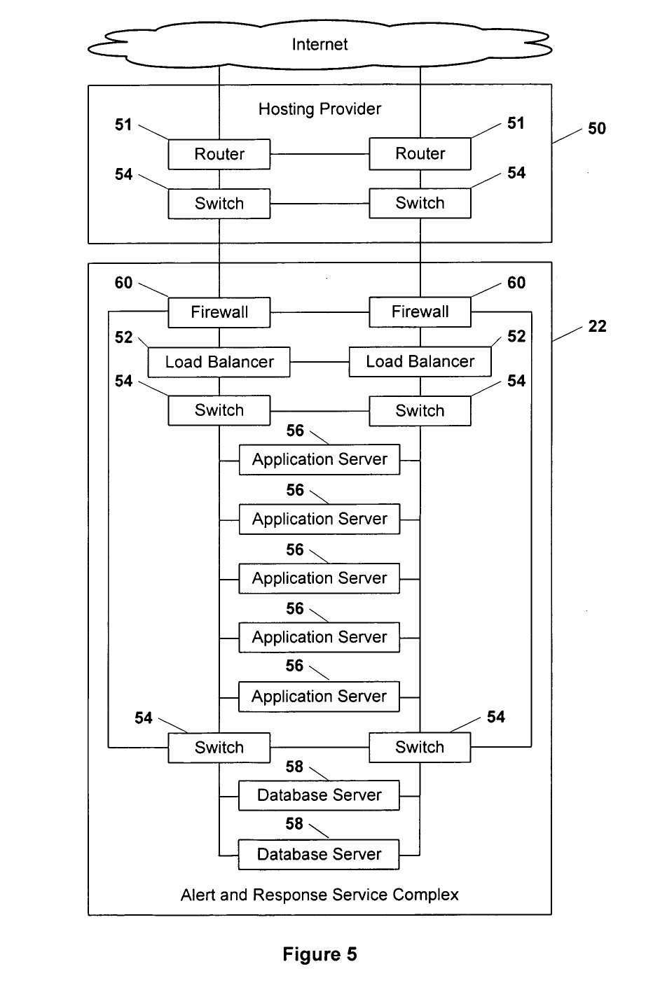

As shown in FIG. 5, each service complex 22 may be configured as follows:
A redundant pair of load balancers 52, e.g., Cisco 11501, which are configured with hardware-based SSL accelerators. The load balancers 52 serve two functions, directing traffic to application servers and providing all SSL encryption and decryption for web traffic. The load balancers 52 direct traffic to the appropriate application server. Classes of application servers operate in either load-balanced or active-passive modes depending on the functions they perform. In load balanced mode, new sessions are directed to the server with the most available capacity, while existing sessions are directed to the server on which the session was begun. In active/passive mode, traffic is directed to the active server. Should the active server be unavailable, a server that had been designated as passive is designated as being active and traffic is directed to the new active server.
One or more redundant pair of switches 54, e.g., Cisco Ethernet (Layer 2). Each pair of switches 54 is trunked together to provide full fault tolerance; should one of the switches fail the traffic is automatically shifted to the other. These switches 54 provide connectivity among the servers and network elements. Virtual Private Local Area Networks (VLANs) are used to segment traffic for security reasons.
A number of application servers 56. Each category of server 56 is configured in either load balanced or active/passive mode. Two or more servers 56 are configured for each category of server to provide redundancy so that no service interruption occurs as a result of a single server failure within each application server category. Each application server 56 is equipped with redundant power supplies and redundant network interfaces. As depicted in FIG. 5, the redundant network interfaces of each server 56 are connected to distinct switches.
A pair of redundant database servers 58 that operate in active/passive mode. If the active database server 58 fails, the passive backup server is promoted to active status. Each database server 58 is equipped with redundant power supplies and redundant network interfaces. As depicted in FIG. 5, the redundant network interfaces of each server are connected to distinct switches.
Highly redundant IP connectivity, provided by the hosting facilities at which the service complexes 22 are located. Self-healing SONET rings over multiple, geographically diverse fiber feeds into the hosting facilities provide IP connectivity to each facility at speeds of OC48 (9.6 Gb/sec). Within the hosting facilities, redundant routers and switches provide high availability Ethernet connectivity to the complexes 22.
Highly available power, provided by the hosting facilities at which the service complexes 22 are located. The power is provided by using redundant commercial feeds, “need+1” (N+1) redundant UPS, redundant PDU, and N+1 redundant backup generators. The batteries attached to the UPS will support full load for at least twelve hour and the generators have fuel on site for at least 24 hours of operation. The power controls and backup generators are tested and maintained on a regular basis.

### Complexes' Security

The service complex 22 is architected, designed, and implemented to be highly secure. It utilizes a “defense in depth” strategy which provides, where feasible, multiple levels of defense. The service complex 22 is a highly distributed, networked service that utilizes IP networking to move information among information sources, information processing nodes, and information sinks. Firewalls are used to restrict the flow of information based on a “need to know” basis.

FIG. 5 shows an example of redundant firewalls 60 that may be implemented in one embodiment of the present invention, for example from Cisco. The firewalls 60 may be configured to block all but three categories of traffic entering the service complex 22. Only HTTP traffic (port 80), HTTPS traffic (port 443), and traffic from the service complex 22's VPN may be allowed to enter. Further, the firewalls 60 may limit the traffic among the servers within the complex 22. For example, traffic to and from the databases located on the database servers 58 is limited to that originating from and terminating on the application servers 56. The firewalls 60 also reduce vulnerabilities to Denial of Service (DoS) attacks.

Sender passwords may be required to log on to the service complex 22 to protect sender accounts, sender administrator account, service complex administrator accounts, and the network elements, servers, and various applications. Sender accounts and passwords may be established by a sender's administrator 26 (FIG. 3) and may be changed by the sender and reset by the customer support representative 40 (FIG. 3). Sender passwords may be case-sensitive and be between seven and fifteen characters in length.

Administrator passwords may be required for use of administration privileges on the service complex 22 and to log on to various system resources. The administrator accounts and passwords may be established and reset by the customer support representative 40 and changed by administrators. The administrator passwords may be case-sensitive and be between seven and fifteen characters in length. To log on, the administrator will have to enter a user name and a corresponding password. In some instances only a password may be required. The administrator accounts and passwords may be established by authorized operations personnel and changed only by them. The administrator passwords are randomly generated, case-sensitive, and may be, for example, ten characters in length.

### Complexes' Data Encryption

All traffic to and from the web interfaces to the service complex 22 is encrypted using 128 bit SSL encryption. SSL, first establishes a private session key using an asymmetric public-key cryptographic algorithm and then encrypts the data exchanged in the session using a symmetric private key cryptographic algorithm. To minimize the possibility of success of brute force attacks, in which an attacker uses trial and error with multiple private keys to decrypt the session data, 128 bit private keys are used. Use of 128 bit keys provides 2¹²⁸ or more than 10³⁰ unique key values. Even if an attacker could try a trillion keys a second, discovering a 128 bit private key by brute force would take, on average, over 5×10¹⁶ centuries. All SSL encryption occurs to and from the service complex 22 is performed by dedicated hardware SSL accelerators in the load balancers 52.

All web applications 56 within the service complex 22 are hardened to eliminate known classes of vulnerabilities to malicious attacks. The classes of attack against which the web applications 56 are hardened include the following: backdoors and debug options; buffer overflows; cookie poisoning; cross-site scripting; hidden field manipulation; null parameter exploitation; parameter tampering; stealth commanding; and third-party misconfigurations. Updates to web applications are hardened and evaluated in a test environment prior to deployment into production.

Basic intrusion detection protection is provided by the firewalls 60 which cut off suspicious traffic and provide real-time alerts of intrusion attempts to the operations personnel. VPNs are utilized among the service complexes 22, operations centers 46, disaster recovery site 48, and corporate headquarters 46B. These VPNs encrypt traffic among these sites and may be based on hardware and software from suppliers like Cisco.

The service complex 22 may be further protected against DoS attacks through a variety of techniques. Such techniques may include SYN Flooding and Authorization Request Flooding. The firewalls 60 in front of each service complex 22, operations site 46, disaster recovery site 48, and headquarters 46B are configured to prevent SYN-flood DoS attacks by limiting the rate at which TCP SYN requests are handled as well as Authorization-Request-flood DoS attacks by reclaiming firewall resources if the firewall authentication subsystem runs out of resources.

### Complexes' Processing

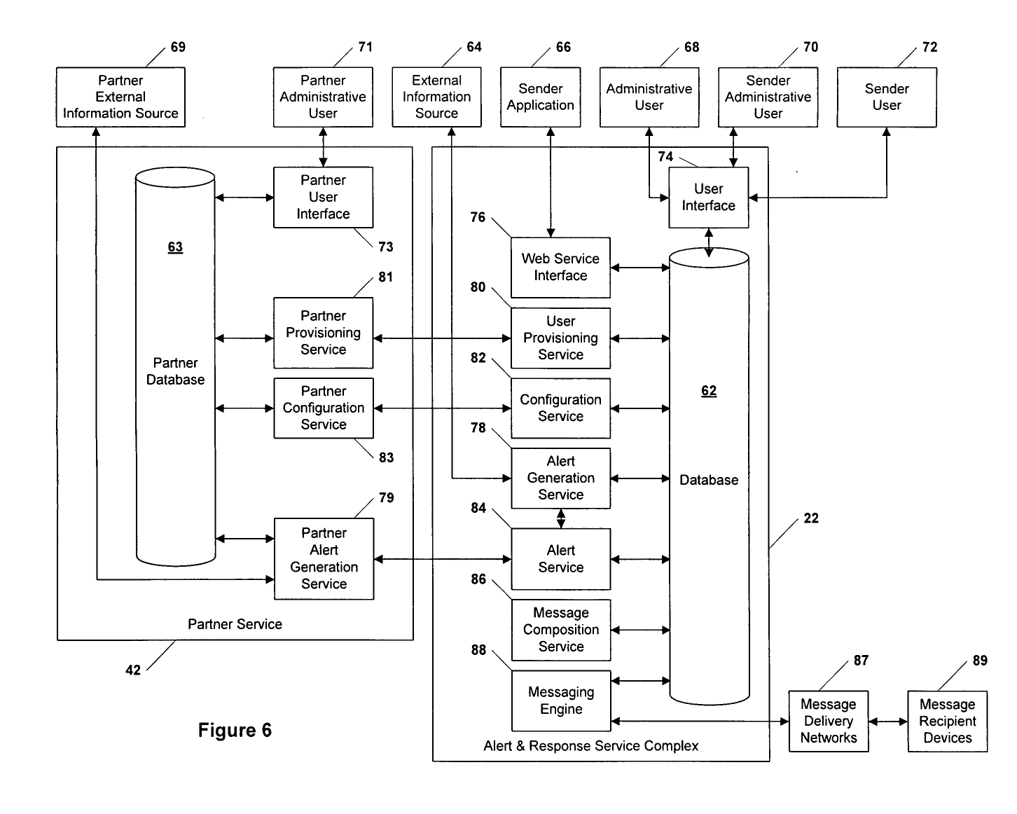

FIG. 6 shows the service complex 22 including a database 62 and a number of interfaces and services interacting with the database. Although only one instance of each interface and service is shown in FIG. 6, it is understood by those skilled in the art that there may be multiple iterations of these applications, either to provide segmentation of the software that carries out the various sub-functions and/or for load balancing.

The database 62 includes all the data and information required to send the alert data or messages discussed above. This information may include: account information for each sender; contact directories with lists of contacts, as well as other information about the contacts including contacts' contact points, e-mail addresses, telephone numbers, etc; preferred and backup modes of contact, e.g., e-mail first and, if there is no response to the e-mail, then a phone call; predefined contact “groups” that the contacts may be assigned to, etc.; message histories indicating when a message went out and to whom; status of the message to each contact, e.g., was the message successfully delivered; reply status in the case where the sender sending the message invoked the “get word back” feature, which requests that the contact reply to the sent message; and other information that would be apparent to those skilled in the art as being necessary to provide the functionalities described herein.

A user interface 74 enables at least three types of users and user applications, including senders 72, local administrators 70, and sender administrators 68. The senders define alerts and initiate sending of the alert data messages. The local administrators 70 perform system configuration, maintenance, and etc. And sender administrators 68 administer senders' accounts including contact directories for communication with the database 62. Similarly, a web service interface 76 enables interaction between sender applications 66 and the database 62 either completely automatically or in response to senders' interactions with those applications. The sender applications 66 provide the same kinds of information to the service complex 22 that an individual user may provide through the user interface 74.

The user interface 74 includes scripts, screens and other software enabling various users, e.g., administrators 68, 70, and senders 72 to interact with the service complex 22 and its database 62 over the Internet and thereby effectuate desired functions. To this end, the user interface 74 accesses the database 62 to retrieve information for display to the users as well as to store new and/or updated information supplied by the users. It is thus via the user interface 74 that individual senders 72 can do the following:
create alert data messages;
define alerts, i.e., events and/or conditions and/or combinations of same which, if they occur, are to trigger the automatic sending of a message.
specify the desired contacts or messages recipients, this is achieved explicitly or by reference to contacts previously stored in the database 62, e.g., in a contacts' directory associated with the sender's 72 account; update contact and contact group lists;
add and/or modify contacts and/or information about each contact, such as telephone numbers, e-mail addresses and the like;
arrange contacts in groups so that a message can be sent to multiple contacts all at once by specifying that the recipients are the members of a particular group;
arrange to receive response data messages from the contacts in reply to the sent messages; and
view message histories that may indicate the status of messages sent, e.g., delivered or undelivered, replied to or not replied to, etc., and other information about the sent messages.

The user interface 74 further allows the sender's administrative users 70 to define the manner in which the various services are to be provided to those working on behalf of the sender, e.g., sender's employees, as well as specifying a list of those authorized to use the sender's account, manage passwords, and so forth.

An alert generation service 78 communicates with external information sources 64, e.g., financial data services, news services, and various monitoring services that may, in one example, provide notification that particular Internet service provider systems have terminated and are unavailable for use. Storing such information, in the database 62 lets the service complex 22 know not to deliver messages to e-mail accounts managed by the unavailable Internet service provider, but instead to a pre-specified alternative service provider or alternative message medium, e.g., the telephone. Thus if the principal manner of alert data delivery to a contact specifies an America On Line (AOL) e-mail address but an external information source 64 reports that AOL e-mail service is currently unavailable, an alternative specified notification method will be automatically used.

A messaging engine 88 interfaces with the message delivery networks 87. On the outgoing side, the messaging engine 88 picks up alert data messages that have been created and placed in the database 62 for transmission by the message composition service 86. The message composition service 86 receive information about the alert data messages to be sent-including message content, the contacts, and selected message delivery options or rules and queues up that information in a standardized form for pick-up and transmission by the messaging engine 88. The message composition service 86 receives the information about the messages to be sent both from the user interface 74 and the web service interface 76, depending on whether message delivery was requested by the sender 72 or from a sender application 66.

The sender applications 66 are of two basic types, administrative and/or configurative in nature to carry out a number of functions, including updating entries of a contacts directory and authorized user lists and changing the content of canned messages, etc. The second type interacts with the service complex 22 so as to cause messages to be sent and can vary widely in the extent to which the sender wishes to rely on the information already having been provided to the service complex 22. At one extreme, the sender may have already supplied the content for a particular message and associated a particular contact group with that message as well as options that the customer may wish to invoke such as “get word back” feature to request a response or “bridge to conference” feature to request that the contact join a conference call. The sender application 66 thus needs only trigger the service complex 22 to send the message.

At the other extreme, the sender applications 66 may rely on nothing more than the fact that the sender has an account set up. In this case, all the information necessary to send out the message is communicated to the service complex 22 at the time it is desired to send the message. This would then include the message content; the contacts and their contact points, i.e., e-mail addresses, phone numbers, etc.; and any service complex 22 options that the customer may wish to invoke.

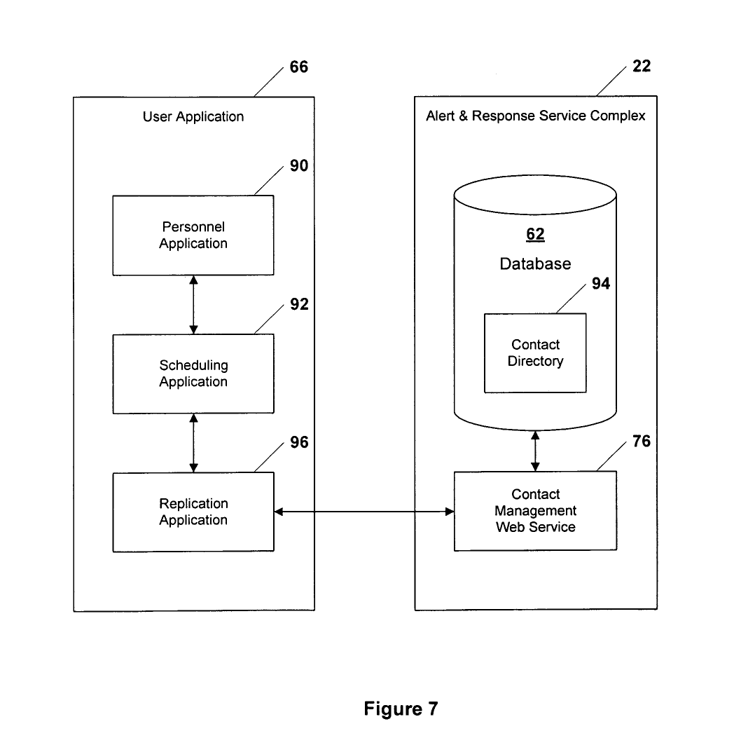

An example of the sender applications 66 is shown in FIG. 7. The sender is a power company having a personnel database managed by a personnel application 90 that includes all personnel involved in repair. This database information is provided to a scheduling application 92 within the power company's computer system that assigns particular repair personnel to particular named workgroups. For example, the company may have five workgroups assigned to workgroups A through E, which are called out to service repair calls within particular segments of the city. On any given day, the composition of the workgroups may change due to vacations, sickness, changes in the long-term repair histories in different parts of the city, etc. Over time, the scheduling application may create new workgroups or eliminate existing ones. The scheduling application will also have information about the assigned-time-of-day work schedules of the various repair personnel and thus has information about who is on duty at any point in time.

The power company may routinely send messages to all the individuals assigned to a workgroup to indicate work-reporting locations or for other purposes. Alternatively, it may only chose to send messages on an emergency basis when repair personnel, including those who may be off-duty at a particular time, are needed to be rapidly deployed to a disaster scene or other emergency location. Such messages might thus be directed to repair people individually as well as by group. For example, it may be desired to notify all the members of workgroups A and B to leave the locations where they might be carrying out minor repairs and to report to a location where a major accident requires the presence of all the individuals comprising the two workgroups.

Effective use of the service complex 22 for this purpose is advantageously achieved by ensuring that a contacts directory 94 within the service complex 22 has all the latest information about who the repair personnel are; what their contact points are, e.g., cell phone number, pager number, instant messaging address, etc.; the composition of each of the workgroups, and etc. In this way, the power company can simply instruct the service complex 22 to send a particular message to all members of workgroups A and B or perhaps to all repair personnel on the payroll.

To this end, the power company computer system may run a replication application 96 to interface with a particular web service interface 76, for example, a contact management web service interface. The replication application 96 is triggered by the scheduling application whenever there is any kind of scheduling change including, for example, addition or deletion of repair personnel to any workgroup. The replication application 96, thereupon, invokes contacts directory update functions of the service complex 22 through the contact management web service interface 76, thereby, updating the composition of contact groups within the service complex 22's contacts directory 94 maintained for the power company. When it is time to send a message to all the personnel in workgroup A corresponding to a like-named group within the contacts directory—the service complex 22 includes the up-to-date information and the message is thus sent to everyone who should get it.

Another example of this concept may be that the sender's proprietary employee database keeps track of the country in which employees, such as traveling executives, are deployed on an ongoing or temporary basis and notifies the service complex 22 as to those country locations. The service complex 22 updates the profile information that it maintains for each contact in the contacts directory 94 to indicate the country where that contact is located. The customer can then define an alert in which messages are to be sent to all the employees located in a specific country if a dangerous situation, e.g., riots, arises in that country. The service complex 22 can then send the desired message upon learning from one of its external information sources of the occurrence of a dangerous situation in that country.

Returning to FIG. 6, the messaging information includes the message content, the desired form of message delivery, and where appropriate associated e-mail addresses, telephone numbers, and etc. On the incoming side, the messaging engine 88 receives any replies to the messages that may have been generated by the contacts, either in response to “get word back” feature prompts or otherwise. The messaging engine 88 also receives status messages from the networks, such as messages indicating that e-mail messages were not delivered, telephone busy signals, or telephone-line-out-of-order recordings from the telephone company. The messaging engine 88 reports all such incoming information in a message history, which is stored in the database and which can be viewed by senders.

### Partner Services

FIG. 6 further shows the partner services 42 interfacing with the service complex 22 to, for example, provide information on the basis of which messages are sent to contacts. Such information may include some stock market event occurring, such as the Dow Jones Industrial Average crossing some predetermined threshold. In another example, a weather monitoring and reporting service providing information about predefined weather conditions such as imminent hurricanes is an example of a partner service. The service complex 22 can use the information from the weather monitoring and reporting service to immediately notify the specified contacts of the reported condition and instruct to take specific action. For example, a school system sender may arrange for its high school sports coaches to be notified via their cell phones, PDAs, etc. when a storm is approaching via a message, such as “terminate all outside sports activity and take cover.” Each partner service 42 may include a number of sub-services that communicate with corresponding sub-services within the service complex 22, as described more fully below.

The partner service 42 initially supplies the service complex 22 with a profile catalog specifying such information as kinds of events that can be monitored and the criteria that the partner service 42 is able to report about those events, such as geographic range of distances, e.g., 10-20 miles, of a particular type of weather event, such as a tornado, from a particular location, for example, Topeka, Kans. The profile catalog is stored in the service complex 22 database 62.

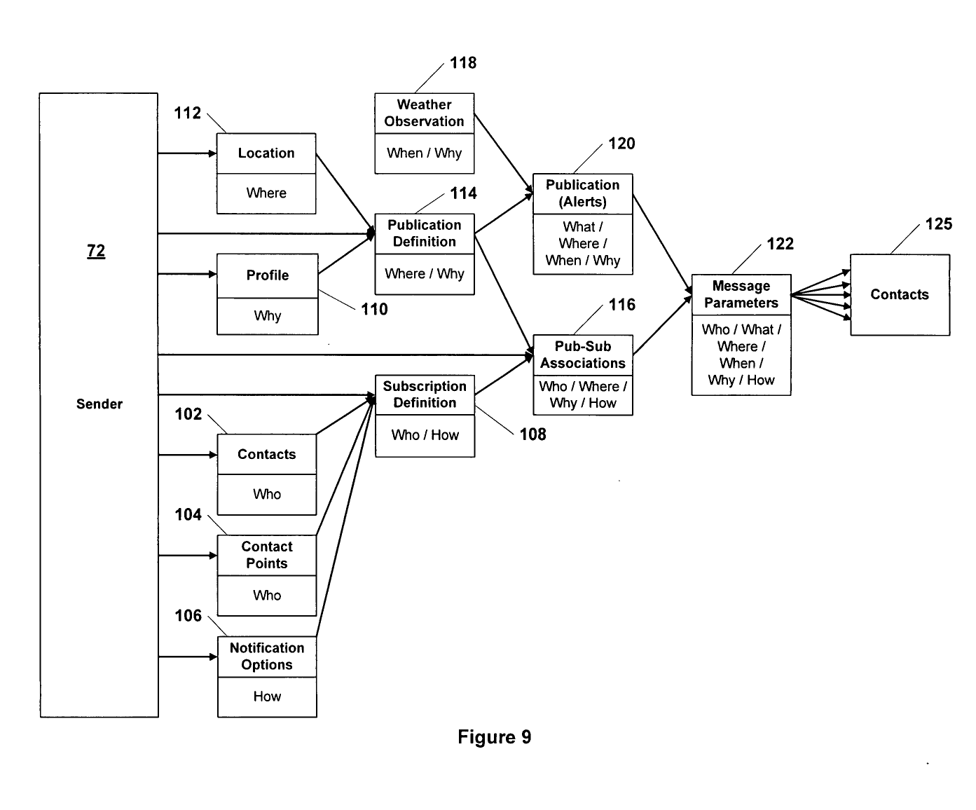

A sender may wish to send a unique message in a specific way when a particular event occurs. The present invention achieves this using alerts received from partner services 42. The sender 72 first accesses the service complex 22 via the user interface 74 and defines the alert in question. As shown in FIG. 9, the sender 72 specifies the contacts 102 and their contact points, e.g., e-mail addresses, telephone numbers, etc., for the message and the notification options 106 including message content, whether “get word back” or “bridge to conference” features are desired, and so forth. This aspect of the alert-defining process is similar to the process undertaken when a non-alert-triggered message is to be sent. The contacts 102, contact points 104 and notification options 106 make up a subscription definition 108.

The sender 72 also specifies the alert event with reference to a stored profile catalog data. This is referred to as a publication definition 114. The publication definition 114 includes a location 112 and profile 110 of the event. The profile 110, i.e., the “why” of the publication 114 defines, for example, the weather condition that the sender cares about, e.g., tornado with 10 miles. The location 112, or the “where” of the publication 114, identifies what geographic location is to be monitored for the condition in question, i.e., Topeka, Kans. The “why” of the publication 114 is so named because it defines why the alert might be generated, e.g., because there's a tornado, but might also be thought of as a “what”, namely what weather condition is of concern to the sender.

The subscription definition 108 and the publication definition 114 are given a subscription identifier and a publication identifier, respectively, by the service complex 22's alert service 84 (FIG. 6). The alert service 84 also creates an association 116 between those two identifiers, all of which are stored in the database 62. The partner service 42 only needs to be aware of the publication definition 114. That is, its job is only to report to the service complex 22 that the event in question has happened. It is the job of the service complex 22 to determine which contacts are to be alerted and to send the alert messages accordingly, when the event occurs. Accordingly, the publication definition 114, but not the subscription definition 108, is transmitted from the alert service 84 to the partner service's alert generation service 79, along with the publication identifier.

This division of labor is analogous to a newspaper operation. Those who create the content and print the physical newspaper do not need to know who the subscribers are or their addresses nor do they need to deliver the newspaper. Those functions are carried out by the subscription and delivery departments.

The partner service 42 carries out ongoing observations 118, e.g., of weather and, in particular, its alert generation service 79 monitors data from partner external information sources 69 to determine if and when the criteria for any given publication definition are met. Once that happens, the partner alert generation service 79 provides an alert 120 to the service complex 22's alert service 84, specifying the nature of the event, e.g., a tornado between 10-20 miles of Topeka, Kans., and the publication identifier of the event. The alert may be in multiple forms, as discussed below. The service complex 22's alert service 84 uses the publication identifier to retrieve the subscription definition 108 and thereupon assembles message parameters 122 based on the contents of the identified publication and the associated subscription. Those parameters are supplied to the message composition service and the messages are delivered to the contacts 125 specified by the sender 72.

A particular advantageous feature of the alerting scenario is that when the partner service specifies the nature of the event, it provides this nature of the event in a number of forms each indicating the occurred event. For example, a message indicating that a tornado occurred 10-20 miles away from Topeka Kans. can be delivered from the partner service 42 to the service complex 22 in the form of (a) a text message to be delivered to those contacts whose specified contact point is text-based, such as e-mails or instant messages; (b) a voice message to be deliver to those contacts whose specified contact point is voice-based, such as a telephone; and (c) a code identifying the event, e.g., a tornado, a lightening strike, etc.

The service complex 22, upon receiving the code, is able to control the way in which the messaging is carried out or configured and/or to provide various kinds of value-added features. For example, when the code indicates that the weather event is 10-20 miles away, the service complex 22 may, pursuant to the pre-specified options, append a warning such as “be prepared to act” whereas if the code indicates that a weather event is less than 10 miles away, the service complex 22 may append a more urgent warning such as “take cover”. Or the service complex 22 may allow the user to specify that if the weather event is close at hand, e.g., less than 10 miles away, the service complex 22 should invoke the “get word back” and/or “bridge to conference” features, but not otherwise.

A two-entity model is inherent in the above-described scenario. A first entity, the service complex 22, allows senders to send messages based on alerts that are to be reported by a second entity, the partner service 42, e.g., weather monitoring and reporting service. The first entity offers up choices for to the sender to define alert conditions based on the types of alerts the second entity is able to provide. The first entity then puts in an order to the second entity with an identifier that enables the second entity to identify when the alert occurred. The first entity can then alert the contacts based on current user preferences. Advantageously, each entity does a portion of the overall task, each doing what it does best and without the need for all information about a transaction to be known or maintained by both entities. In this particular case, for example, the weather reporting partner has no need to know anything about the messaging aspects of the alert. It only needs to report the weather event in question if and when such event should occur.

Another advantageous aspect of the disclosed invention is that the service complex 22 customizes message notification based on how a particular event manifests itself. Thus it allows users to specify that “get word back” feature should be invoked when a tornado is particularly close-thereby allowing users to confirm that everybody got the message but that “get word back” feature should not be invoked if the tornado is further out and the chances of the tornado coming this way are relatively small.

Although weather related scenario is used to illustrate several advantageous aspects of the disclosed invention, a wide variety of applications beyond weather alerting may be used as partner services 42.

### Complexes' Processing (Continued)

A user provisioning service 80 sets up accounts with new senders, it interacts with sender administrative users 70 through the user interface 74 to set up new accounts and to add users to existing accounts. In another aspect, the sender provisioning service 80 interacts with a partner service's 42 provisioning service 81, wherein the partner service 42 may have “signed up” a sender who, for example, wishes to receive alert messages based on data that the partner generates. For example, if the partner service 42 is the weather monitoring and reporting service, the sender may wish to be availed of weather alert messaging.

An alert generation service 78 monitors the external information sources to determine if alert conditions specified by senders 72 or sender applications 70 have occurred. Alerts can also include time-of-day criteria as well as criteria of various other sorts.

Alert service 84 receives alerts from the alert generation service 78 and accesses information in the database 62 as to what is supposed to happen when that alert occurs, who is supposed to be informed, with what message content, with what options, etc. The alert service 84 thereupon assembles information necessary to send the messages based on what was specified by the sender, including the content of the message, i.e., delivered, for example, as text or synthesized voice, the contacts and their contact points, i.e., e-mail addresses, telephone numbers, etc., and other options that may have been selected by the customer for this particular alert, such as whether “get word back” or “bridge to conference” feature is desired. As with messages composed via the user interface 74 and web service interface 76, the alert messages are put in a queue within the database 62 for pick-up and transmission by the messaging engine 88.

In another aspect, the alert service 84 also triggers the sending of messages upon the occurrence of conditions being monitored in whole or in part by the partner service 42 as requested by a sender. For example, where the partner service 42 is the weather monitoring and reporting service and a user may have defined as an alert the occurrence of a tornado within 20 miles of Topeka, Kans. If such condition occurs, a partner alert generation service 79 alerts the alert service 84 to the condition. The alert service 84 thereupon matches up that alert with the particular senders who defined it, and appropriate messages are generated and sent out as described above.

A configuration service 82 interacts with a partner configuration service 83 by receiving from the partner configuration service 83 information referred to as the profile catalog. In the case of the weather monitoring and reporting service, the profile catalog illustratively includes the type of weather conditions that the partner service 42 is able to report, e.g., temperatures, high winds, hurricanes, tornadoes, as well as the kinds of details that the partner service 42 is able to supply relative to those weather conditions, e.g., that a hurricane or other storm is, say, 0 to 10, 10 to 20, 20 to 30 or greater than 30 miles away from a given specified geographical location. Such information enables defining of alerts.

Further interaction between the respective configuration services 82 and 83 involves the service complex 22 informing the partner service 42 of the conditions and/or criteria that, if met, should be reported by the partner service 42. For example, if, as suggested above, the customer wishes a message to be triggered if a tornado appears within 20 miles of the center of Topeka, Kans., the configuration service 82 must tell the partner service 42 that that is a condition that the service complex 22 needs to know about. If that condition does occur, the partner service's alert generation service 79 will provide an indication to the service complex 22's alert service 84, leading to the sending of messages as described.

### Complexes' Processing Sequences

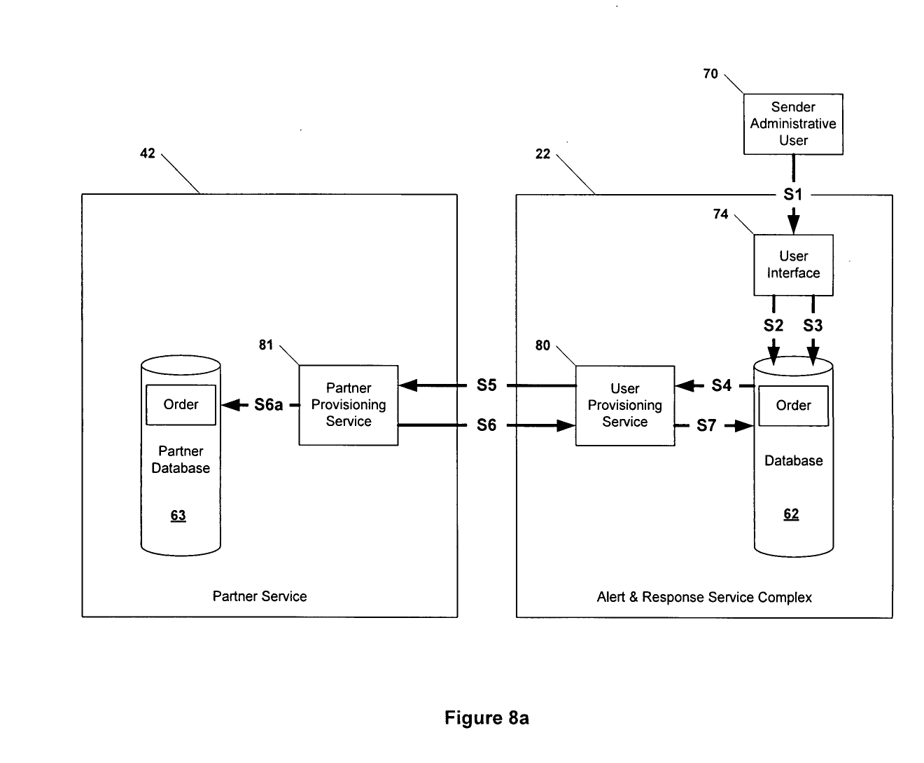

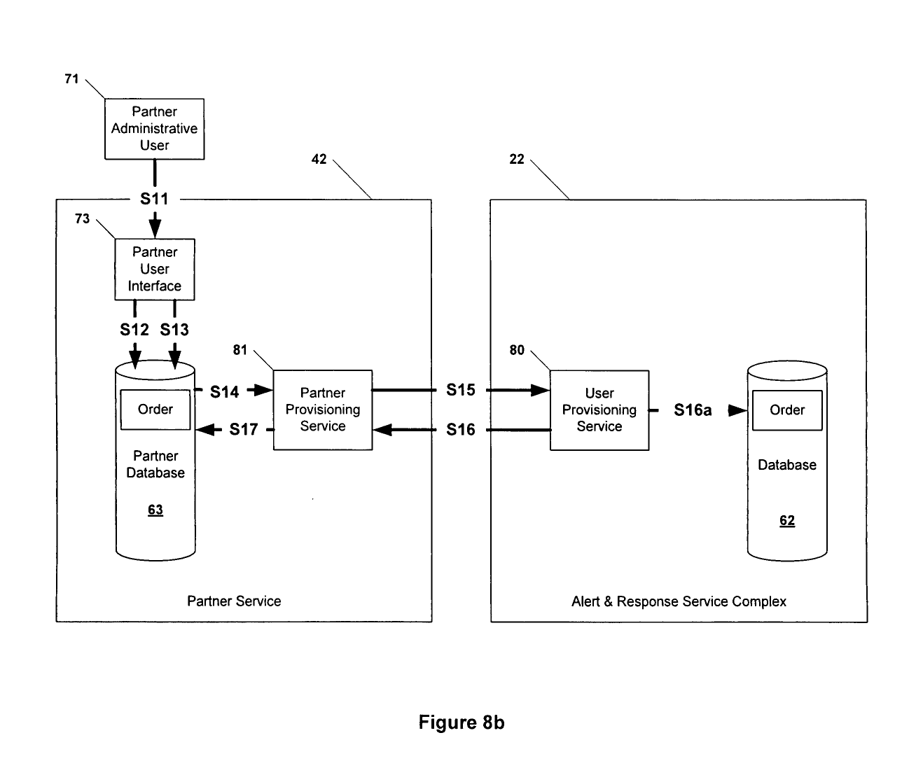

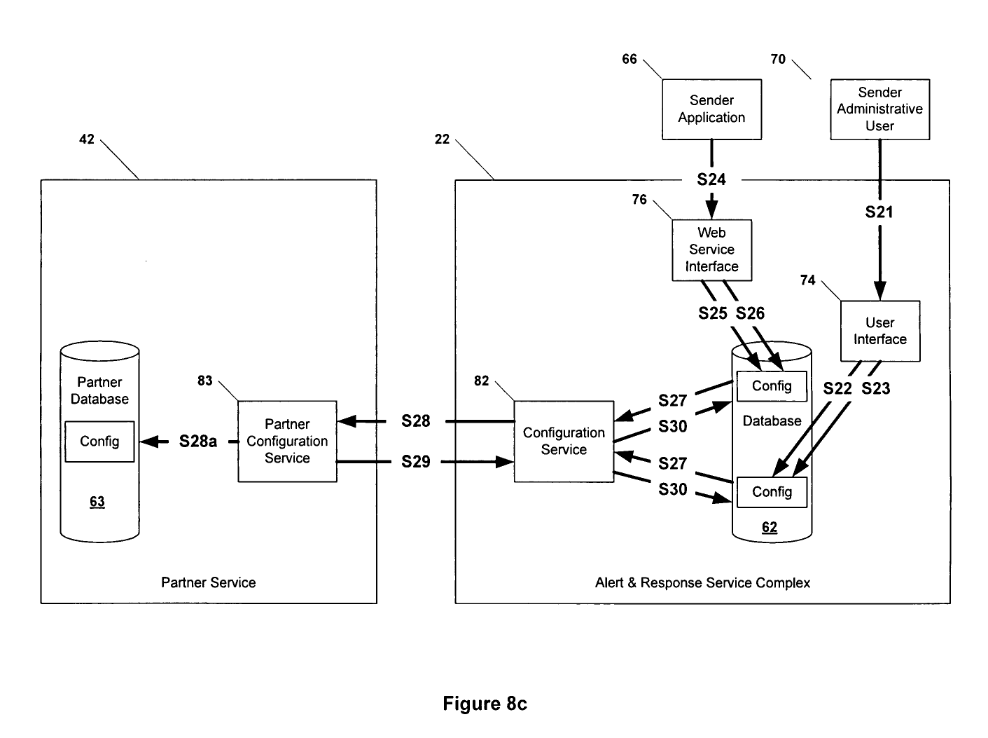

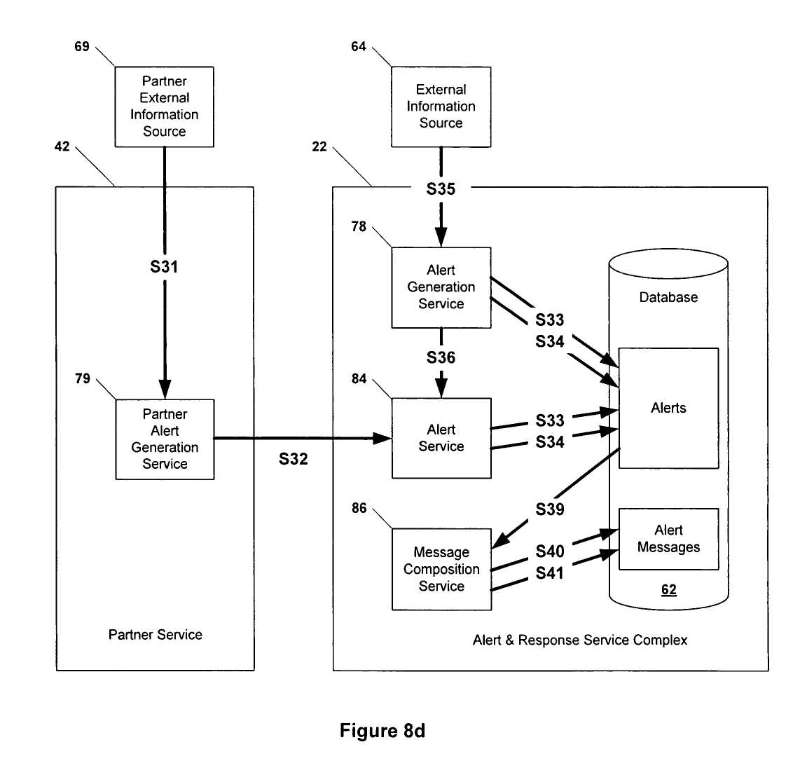

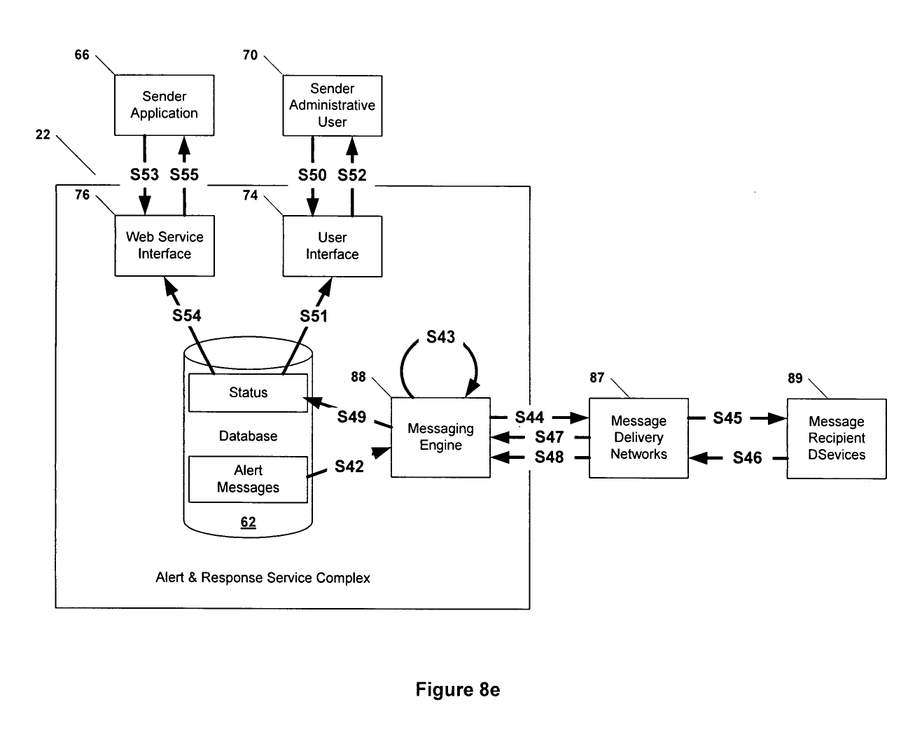

FIGS. 8a-8e show a number of individual process iterations of provisioning 80 (FIGS. 8a and 8b), configuration 82 (FIG. 8c), alert 84 (FIG. 8d), message composition 86 (FIG. 8e), and message engine 88 service processes (FIG. 8e) of the service complex 22 as illustrated in FIG. 6.

In FIG. 8a, the service complex 22 is the primary services provider, in step S1, the sender administrative user 70 enters orders through the user interface 74. The user interface 74, in step S2, stores the entered orders in the database 62 and, in step S3, marks thus saved orders as unprocessed. In step S4, the provisioning service 80 determines the order items in the database 62 that are marked as unprocessed and, in step S5, passes that information to the partner provisioning service 81, typically through a web service. In step S6 the provisioning service 80 receives confirmation from the partner provisioning service 81 that the information has been received and, in step S7, marks the order items in the database 62 as processed. The partner provisioning service 81 may optionally, in step S6a, store the information about order items in the database 62 that are marked as unprocessed in the partner database 63.

Alternatively, as shown in FIG. 8b, where the partner service 42 is the primary services provider, in step S11 the partner administrative user 71 enters the order through the partner user interface 73; in step S12 the order information entered is then stored in the partner database 63 and, in step S13 marked as unprocessed. In step S14, the partner provisioning service 81 finds the order items that are marked as unprocessed and, in step S115, passes the information to the provisioning service 80, typically through a web service. In step S16 the partner provisioning service 81 receives confirmation from the provisioning service 80 that the information has been received and, in step S17, marks the order items in the database 63 as processed. The provisioning service 80 may optionally, in step S16a, store the information about the order items in the partner database 63 that are marked as unprocessed in the database 62.

FIG. 8c illustrates configuration process. In step S21, the sender administrative user 70 configures the service through the user interface 74. The configuration information includes publication definitions, subscription definitions, and the association between publications and subscriptions. The publication definitions include locations, information profiles, and the associations between locations and information profiles. The subscription definitions include recipients, recipient contact mode and addresses/numbers, and notification rules and options. In step S22, the user interface 74 stores the configuration information in the database 62 and, in step S23 marks appropriate portions as unprocessed.

In step S24, the sender application 66 configures the service through the web services interface 76. In step S25 the web services interface 76 stores the configuration information in the database 62 and, in step S26, marks appropriate portions as unprocessed.

In step S27, the configuration service 82 finds the configuration information items that have been marked as unprocessed and, in step S28 passes the unprocessed configuration information items to the partner configuration service 83, typically through a web service. In step S29 the configuration service 82 receives confirmation from the partner configuration service 83 that the information has been received and, in step S30 marks the items as processed. The partner configuration service 83 may optionally, in step S28a, store the unprocessed configuration information items in the partner database.

FIG. 8d illustrates the alert process. In step S31, the partner alert generation service 79 monitors the partner external information sources 69 for conditions that match one or more publication definitions. For each such match, in step S32, an alert is passed to the alert service 84, typically through a web service. The passed alert includes an identifier (publication ID) that identifies the publication definition, one or more versions of the alert body, and an XML representation of the alert. In step S33, the alert service 84 stores the received alerts in the database 62 and, in step S34, marks it as unprocessed.

Similarly, in step S35, the alert generation service 78 monitors the external information sources 64 for conditions that match one or more publication definitions. For each such match, in step S36, an alert is passed to the alert service 84. The alert includes an identifier that identifies the publication definition, one or more versions of the alert body, and an XML representation of the alert. In step S37, the alert generation service 78 stores the received alerts in the database 62 and, in step S38, marks it as unprocessed.

Alert messages are composed in step S39 by the message composition service 86, which finds each alert item that is marked as unprocessed in the database 62 and picks it up for processing. Using the publication ID of the alert and the associations between publications and subscriptions, this process next determines the subscriptions to which this alert is to be sent. Individual messages are assembled using the recipients, recipient contact modes and addresses/numbers and the appropriate alert body taking into account the appropriate associations between alert body types and contact modes. Rules and/or options specified in the subscription definitions, e.g., “silence periods” during which no messages are to be sent, soliciting responses, and connecting voice calls to conference bridges, are applied. In step S40, the messages that result from this process are stored in the database 62 and, in step S41, are marked as unprocessed. Among the attributes of each message is its delivery time, the time until which the message should hold prior to its being sent.

Message delivery is illustrated in FIG. 8e. In step S42, the messaging engine 88 finds the messages created by the message composition service 86 that are marked as unprocessed in the database 62 and whose delivery time is not set in the future and picks them up for processing. In step S43, delivery rules, such as an expiration time within the XML representation of the alert being a time in the past are applied. If sending rules dictate that the message should be sent, in step S44, the messaging engine 88 formats and passes the message to an appropriate message delivery network 87; the choice of which message delivery network 87 to use for any given message is based on a message mode, the real-time capacity and status of the available message delivery networks 87, and the cost of delivery for each of the available message delivery networks 87.

In step S45, the selected network of the message delivery networks 87 to which the message was passed, delivers the message to the designated message recipient device 89 using the message address or number. If a response to the message has been requested and the message recipient provides one in step S46 to the message delivery network 87, the message delivery network 87 provides the response to the message engine 88 in step S47. In addition, the message delivery network 87 provides the status of message deliveries, e.g., delivered, mailbox full, reached an answering machine, busy to the message engine 88 in step S48. In step S49, the message engine 88 stores the message status and the responses, if any, in the database 62.

In step S50, the sender administrative user 70 may requests the message status and the responses from the user interface 74. In response, in step S51, the user interface 74 may retrieve the message status and the responses, if any, from the database 62 and provide them to the sender administrative user 70 in step S52.

Similarly, in step S53, the sender application 66 may requests the message status and the responses from the web services interface 76. In response, in step S54, the web services interface 76 may retrieve the message status and the responses, if any, from the database 62 and provide them to the sender application 66 in step S55.

### Other Advantages

When messages, e.g., e-mails, are transmitted to contacts, they are sometimes not received. It is desirable to report to the senders the status of sent messages, including indications and the reasons the e-mail wasn't received. To some extent the reason for non-delivery can be learned from so-called RFC reply codes that are returned to e-mail senders, i.e., the messaging engine 88 (FIG. 6). Typical RFC reply codes are 450 indicating that a mailbox is unavailable, e.g., mailbox busy and 552 indicating that storage allocation is exceeded, e.g., mailbox full. The invention improves on this by providing better information by conducting a lexical analysis of any return message, either from the Internet or from the contacts' e-mail systems to discover the status of the message. For example, analysis of the text of an auto-reply vacation message can determine that the contact is, in fact, on vacation—a fact that can be reported in the message status.

Providing better information to the senders is extended to media other than e-mail. For example, for voice messages it is sometimes possible to recognize telephone call progress signals, such as busy, fast-busy, in order to provide a status report for a voice call. In addition, voice recognition may be applied to recorded messages received from the telephone company, such as “the number you have reached is not in service at this time” in order to be able to report to the sender why a message sent by telephone did not go through.

The service complex 22 aggregates the statuses of all instantiations of a particular sent message, thereby providing a readily reviewable report to the sender as to what happened with respect to the message in question-how many deliveries were successful, how many attempted deliveries were unsuccessful for reason X or Y or Z, etc.

Further, the service complex 22 can flag a mode of communication about to be used in sending a message to a particular contact based on an external event. For example, if the message is to be sent via e-mail and a particular contact's e-mail provider is America on Line, and the notification system has learned from one of its external information sources that America On Line is down, the system can prompt the user with a message such as “AOL is down; suggest selecting an alternative form of message delivery to this contact.”

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A method of enabling one or more senders to simultaneously alert one or more contacts located anywhere around the world over one or more communication networks, each contact having at least one communication device for receiving alert data, the method comprising the steps of:
generating one or more scenarios each including a set of destination contacts selected from the one or more contacts, a composition of alert data, and delivery rules;
initiating execution of at least one of the scenarios to send the alert data to each contact in the set of destination contacts; and
managing sending of the alert data by applying the delivery rules.

2. The method of claim 1, wherein the messages are selected from newly composed or pre-existing alert data for expressing alerts and other types of information in a form selected from telephone calls, e-mail messages, instant text messages, and etc.,
the senders are selected from individuals and authorized personnel of various organizations, companies, and corporations,
the contacts are selected from individuals designated by the senders and senders' employees and customers, and
the communication networks are selected from common voice, text, and data networks.

3. The method of claim 1, wherein the communication devices are selected from land-line based telephones, cell phones, Internet phones, personal digital assistants, Black Berry devices, and computing devices.

4. The method of claim 1, further comprising the steps of:
the contacts receiving the alert data; and
responding to the receipt of the alert data in a manner selected from one of at least sending response data directly to the sender's communication device via the communication networks and connecting to the sender in a pre-arranged conference bridge, the conference bridge connecting the sender and the one or more contacts from the set of destination contacts for a conference call over at least one of the communication networks.

5. The method of claim 4, further comprising a step of the sender providing a request for response in the alert data, wherein
the connection of the one or more contacts to the conference bridge is initiated in response to the request for response received in the alert data and
the response to the receipt of the alert data is performed in response to the request for response received in the alert data.

6. The method of claim 5, wherein the response to the receipt of the alert data is performed over the communication networks selected from common voice, text, and data networks using the communication devices selected from land-line based telephones, cell phones, Internet phones, personal digital assistants, Black Berry devices, and computing devices.

7. The method of claim 6, wherein the one or more scenarios are formed on a service complex having at least one computing device connected to the one or more communication networks and
verifying and recording delivery and status of the sent alert data and received response data in real time, and
enabling presentation of voice and text data received within the response data as generated.

8. The method of claim 7, wherein the scenarios include content of the alert data, a directory of contacts to whom the alert data is to be sent, rules describing how the alert data is to be delivered, and criteria for initiating execution of at least one of the scenarios without prompting by the senders.

9. The method of claim 8, further comprising the steps of:
monitoring external events to detect trigger events listed in the scenarios; and
automatically initiating execution of at least one of the scenarios to send the alert data to each contact in the set of destination contacts in response to detected trigger events.

10. The method of claim 9, wherein the external event triggers are selected from at least one of date and time, weather events, stock market events, and news events.

11. The method of claim 10, wherein the one or more contacts are directories of contacts' identifications and addresses maintained by at least one of the senders, administrators appointed by the senders, and by the contacts, the directories are imported from senders' computing devices, third party computing devices and maintained on the service complex.

12. The method of claim 11, wherein the application of the delivery rules comprises the steps of:
prioritizing the alert data to meet service level agreements (SLAs) and other contractual commitments while minimizing costs;
routing the alert data to specific communication networks;
tracking a status of the execution of the scenario and of the messages contained within the scenario; and
creating message detail records for billing.

13. The method of claim 12, wherein the initiating execution step further comprises the step of formatting the alert data for delivery over one of the one or more communication networks selected by the sender and specific to a service provider and the communication device of the contact.

14. The method of claim 13, further comprising the step of monitoring presence of the contact's communication device on the communication network prior to sending of the alert data and sending of the alert data to the contact's alternate communication device if the communication device is not present.

15. The method of claim 1, further comprising a step of maintaining a plurality of scenarios, wherein the initiating execution step utilizes a scenario selected from at least one of the plurality of maintained scenarios and the one or more generated scenarios.

16. The system of claim 4, wherein the service complex further comprises:
one or more partner services for providing information on which basis alert messages are automatically sent to contacts, each partner service supplies the service complex with a service profile catalog specifying kinds of events that can be monitored by the partner services and the information about those events that will be provided; and
an alert service for communicating a notification from one or more partner services to send the alert.

17. The system of claim 20, wherein the information provided by the one or more partner services is in the form selected from at least one of text to be delivered to the contacts, voice recording to be delivered to the contacts, and a code identifying the event.

18. A system for enabling one or more senders having access to a service complex to simultaneously alert one or more contacts located anywhere around the world, each contact having at least one communication device serviced by one or more service providers, the service complex comprising:
at least one computing device;
a database residing on the at least one computing device;
one or more communication networks connected to the at least one computing device for communicating alert messages;
an interface for administering scenarios and initiating sending of the alert messages;
an alert generation service for communicating with external information sources to receive notification to send the alert messages; and
a messaging engine for sending the alert messages to the contacts' designated communication devices managed by available service providers.

19. The system of claim 18, wherein the database includes
account information for each sender;
contact directories with lists of contacts and information about the contacts including contacts' contact points, e-mail addresses, and telephone numbers;
preferred and backup modes of contact;
predefined groups of contacts including at least one of the one or more contacts;
message histories indicating when an alert message went out and to whom;
status of the alert message to each contact; and
response status where the sender invoked the “get word back” feature requesting that the contact respond to the sent alert message.

20. The system of claim 19, wherein the interface is selected from at least one of Graphics User, Command Line, and Web services Interfaces.

21. The system of claim 20, wherein the interface enables
creation of alert messages;
defining of events and conditions for alerts to trigger automatic sending of the alert message;
selecting a set of desired contacts from the one or more contacts previously stored in the database;
adding and modifying contact information;
arranging to receive response messages from the contacts in reply to the sent alert messages; and
viewing message histories that may indicate the status of messages sent, e.g., delivered or undelivered, replied to or not replied to, etc., and other information about the sent messages.

22. The system of claim 18, wherein the external information sources provide notification data selected from at lest one of information of availability of the service providers, financial data, and the news.

23. The system of claim 22, wherein the messaging engine further receives status messages from the one or more communication networks over which alert messages were sent, the status messages indicate non-delivery of alert messages and are stored in the database for review by senders.

24. A process executed on at least one computing device having at least one database and connected to one or more networks, said process being accessible by one or more senders for enabling said senders to simultaneously alert one or more contacts each having at least one communication device connected to said networks, the process comprising:
at least one interface for receiving orders and configurations from said senders, storing said orders and configurations in the database, and marking said orders and configurations as unprocessed;
a first configuration service for ascertaining unprocessed configurations in the database and passing said unprocessed configurations to a partner configuration service, said configuration information including one or more publication definitions, one or more subscription definitions, and the association between publications and subscriptions;
at least one alert service for generating alerts when conditions match one or more of the publication definitions, storing said alerts in the database, and marking said alerts as unprocessed, the alert including an identifier that identifies the publication definition, one or more versions of the alert body, and an XML representation of the alert;
a message composition service for retrieving alerts that are marked as unprocessed, determining the subscriptions to which the retrieved alerts are to be sent, assembling alert messages, storing said alert messages in the database, and marking said alert messages as unprocessed; and
a messaging engine for identifying the alert messages that are marked as unprocessed in the database and whose delivery time is not set in the future, applying rules, and if rules permit sending the alert message to the at least one communication device of the one or more contacts.

25. The process of claim 24, further comprising a first provisioning service for ascertaining unprocessed orders in the database and passing said unprocessed orders to a second provisioning service, said first and second provisioning services being selected from partner and local provisioning services;

26. The process of claim 25, wherein after receiving confirmation that the information has been received, the first provisioning service marks said orders and the first configuration service marks said configurations in the database as processed.

27. The process of claim 25, wherein
said publication definitions including locations, information profiles, and the associations between locations and information profiles;
said subscription definitions include recipients, recipient contact mode and addresses/numbers, and notification rules and options.

28. The process of claim 27, wherein the alert messages are assembled using the recipients, recipient contact modes and addresses and telephone numbers and the appropriate alert body and rules specified in the subscription definitions.

29. The process of claim 24, wherein the messaging engine formats and passes the message to an appropriate network of the one or more networks and storing sent message status and response to the sent message in the database.
